(19) United States
(12) Patent Application Publication
(10) Pub. No.: US 2006/0233935 A1
(43) Pub. Date: Oct. 19, 2006

(54) Rhamnolipids in bakery products

(76) Inventors: Ingrid Paul Hilda Van Haesendonck, Mechelen (BE); Emmanuel Claude Albert Vanzeveren, Brussels (BE)

Correspondence Address: KNOBBE MARTENS OLSON & BEAR LLP, 2040 MAIN STREET, FOURTEENTH FLOOR, IRVINE, CA, 92614, US

(21) Appl. No.: 10/533,499

(22) PCT Filed: Nov. 1, 2003
(86) PCT No.: PCT/BE03/00186

§ 371 Date: Apr. 13, 2006

(30) Foreign Application Priority Data
Nov. 4, 2002 (EP) 02447207.8

(51) Int. Cl. A23D 9/00

(52) U.S. Cl. 426/601

(57) ABSTRACT

The present invention is related to a method for the improvement of dough or batter stability, dough texture, volume and shape, width of cut and/or microbial conservation of bakery products which comprises the step of adding a sufficiently effective amount of rhamnolipid(s) to said bakery products. The present invention further relates to an improver for the improvement of dough or batter stability, dough texture, volume and shape, width of cut and/or microbial conservation of bakery products, characterized in that it comprises a sufficiently effective amount of rhamnolipids. The rhamnolipids can further be used to improve the properties of butter cream, decoration cream and/or of non-dairy cream filling for Danish pastries, croissants and other fresh or frozen fine confectionery products.

### FIELD OF THE INVENTION

The present invention concerns use of rhamnolipids for volume enhancement and for texture modification in bakery and pastry products.

### BACKGROUND OF THE INVENTION

The consumers prefer to buy voluminous loaf of bread with a well aerated and supple texture. Volume increase has always been a challenge to producers of bakery ingredients.

Traditionally the volume is obtained by use of yeast. The loaf's volume is due to fermentation that produces carbon dioxide and ethanol (rising). This gas is expanded and the ethanol is evaporated by heating during the baking. This phenomena causes gas bubbles into the dough. The flour's quality and the baking process have much importance. The kneading is essential to incorporate air into the dough. Temperature and time during fermentation have much influence on yeast growing and thus on carbon gas production. The optimal temperature for yeast fermentation is between 28°-32° C. Indirectly, each parameter influencing yeast's growing and yeast's fermentation should have effect on volume.

Bakers often want to reduce fermentation time and have voluminous loafs with all flour's qualities at the same time.

There is a number of ingredients known to improve the volume of bread. Ascorbic acid is well known to enhance volume since 1935 (Food Biochemistry, Belitz H. O. and Grosh W., second edition, Springer, Berlin, 1999, 670-671). Flour with 20 to 200 ppm ascorbic acid added, gives loaf with a bigger volume.

Another oxidant agent giving sensible volume increase is potassium bromate. Quantities of around 100 ppm increase the volume about 25% but in most countries the bromate level is limited up to 75 ppm. When it is used at higher rates it will open crumb structure of the breads and will cause a bad smell in the bread.

ADA or Azodicarbonamide is also of interest as a flour improver.

Enzymes like fungal α-amylases or xylanases have also good effects on bread's volume. Fungal α-amylases hydrolyse starch and increase the concentration of free sugars. These free sugars can be fermented by the yeast giving more volume (Cauvain S. P. and Chamberlain N., (1988), Journal of Cereal Science 8, 239-248).

The xylanases will hydrolyse at random in the xylan backbone of arabinoxylan which can lead to the breakdown of water un-extractable arabinoxylan into water extractable arabinoxylan and as a consequence the volume will increase (U.S. Pat. No. 3,512,992).

Emulsifiers like DATEM (Diacetyl Tartaric Acid esters of monoglycerides) are already used since decades. DATEM has a positive influence on the volume when it is used between 0.1% to 0.5% (Kohler P. and Grosh W. (1999), Journal of Agriculture and Food Chemistry, 47 (5) 1863-1869). Usages above 0.5% don't have any additional volume effect. This volume effect can be explained by the chemical structure of DATEM. DATEM is able to link hydrophobic and hydrophilic parts of different gluten chains so that a better developed gluten network is obtained. Another explanation can be found in the liquid layer theory that purposes better gas retention by a liquid structure around the gas bubbles (Tsen C. C. and Weber J. (1981), Cereal Chemistry, 58 (3) 180-181).

CSL and SSL (respectively Calcium stearyl lactate and sodium stearyl-2-lactate) have also significant effect on volume but less than DATEM (Lorenz K. (1983), Bakers Digest. 57 (5), 6-9). With 0.3% of SSL the loaf's volume rises around 105%.

Use of glycoside ester of condensate of a polyol and a pyranoglycosyl as volume improver in bread is patented (GB 1 322 706).

Active components extracted from residues of ethanolic and other fermentations of microorganisms are natural improvers for yeast raised goods. Those components include nicotinamide adenosine dinucleotide and its phosphate, flavin adenosine nucleotide etc. and are “natural” reducing-oxidising agents who can replace “chemical” ones such as potassium bromate, sodium bisulfite, azodicarbonamide, etc. (International Patent Application WO 88/03365).

Volume enhancing is generally associated with texture modification. These modifications are mostly positive. They can improve the crispiness of the crust and the softness and elasticity of the crumb. On the contrary, additives like monoglycerides have an effect on softness but no significant effect on volume.

Volume enhancing is limited first by the additive's limits. A maximal volume is for instance obtained with around 0.3% of DATEM. This concentration gives a volume increase of 25 to 40% depending on flour quality, process and the presence of other additives

Economical and technical constraints further limit the use of large quantities of additives.

Finally, consumers prefer additives that are not the result of chemical synthesis and prefer to be subjected to the lowest possible doses of additives. If two or more additives can be replaced by one additive that is able to achieve a similar effect, this is highly advantageous.

### STATE OF THE ART

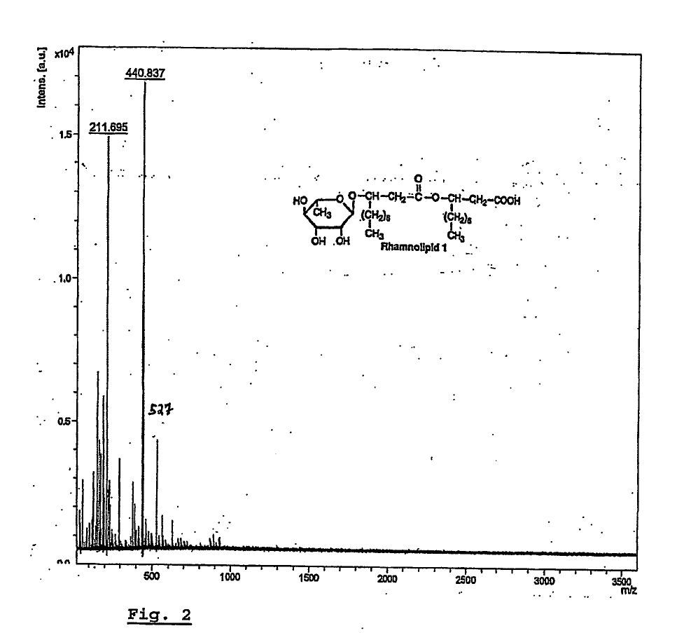

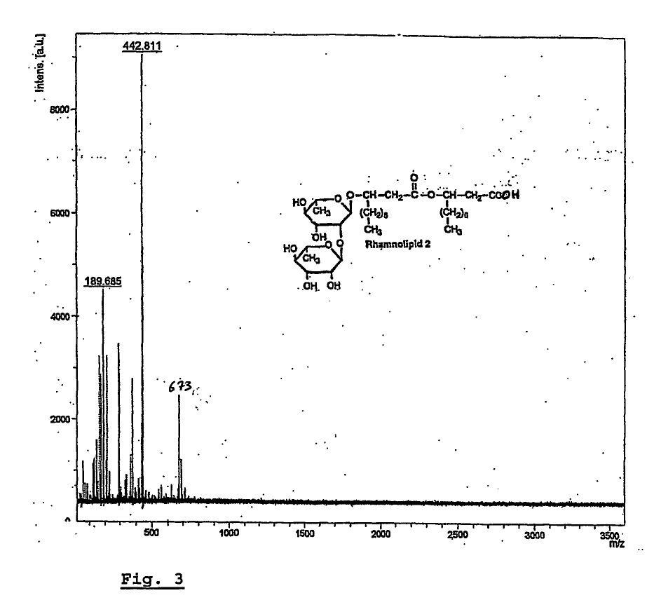

Rhamnolipid is a surface active agent containing rhamnose and most commonly beta-hydroxydecanoic acid (e.g. DE 196 28 454 A and Mata-Sandoval et al., 1999 (Journal of Chromatography 864:211-220), incorporated herein by reference with respect to the structure, names and classification of rhamnolipids, see also FIGS. 2 and 3). Mata-Sandoval et al. (see above) is further incorporated herein with respect to the major and minor rhamnolipids produced by Pseudomonas species.

Rhamnolipids can lower both the air/water and the hexadecane/water surface tension significantly.

Practical applications of rhamnolipids as bioemulsifier include for instance decontamination agent in oil areas, tertiary oil recovery and in cosmetic and pharmaceutical sector (BE 1 005 825 A and U.S. Pat. No. 4,814,272). They are also added to culture media or the like to promote or induce microbial growth (U.S. Pat. No. 4,628,030). The only uses of rhamnolipids described in food are to preserve freshness of fruits, to emulsify flavour oils and as flavours precursors, and further their use in pastry and ice cream, their use as aid in the cooking of fats and oils or at the crystallization of sugars through improvement of the washing (BE 1 005 825 A), or their use as source of rhamnose sugar (International Patent Application WO 00/29604 and U.S. Pat. No. 4,814,272).

A possible source of rhamnolipids is the culture broth of Pseudomonas sp fermentation (e.g. U.S. Pat. No. 4,814,272) or chemical synthesis. Attempts are made to have these rhamnolipid bioemulsifiers produced by genetically modified micro organisms.

### SUMMARY OF THE INVENTION

A first aspect of the present invention is related to the use of rhamnolipids in a method to increase the stability of the dough or batter and the volume of the baked product (including but not limited to bread, cake or sponge cake), to improve the structure of the crust and/or the crumb during the baking process, to improve the shape of the bakery products (like width of cut, a more round shape for rolls etc.) and/or to decrease microbiological deterioration of the baked product (i.e. to improve their microbial conservation). For bakery products an increased dough or batter stability means improved shock resistance (important during mechanical operations), improved resistance to collapse during prolonged fermentation, improved oven jump (e.g. width of cut of incised products) and shape of the resulting product. Said method or use comprises the step of adding a sufficiently effective amount of the active component to the ingredients of said bakery products. According to an embodiment of the invention, at least 0.01% (w/w) and more preferably at least 0.025% (w/w) of rhamnolipids is added to the dough, batter or dry matter to obtain the desired effect. For instance, doses between about 0.01% (w/w) and about 0.6% (w/w) on flour were used and found sufficient, more preferably doses between about 0.02% and about 0.5% were used, even more preferably doses between about 0.025% and 0.3%. Depending on the recipe used variations in the amount of rhamnolipids needed may arise though.

Rhamnolipids have a surprisingly good effect compared to other standard emulsifiers and additives that have been used over the past decades. The emulsifier DATEM for instance is being used for more than 30 years now, and it is only now that a bioemulsifier has been found which can not only compete with existing emulsifiers and additives, but can be used at surprisingly lower amounts than typically applied for emulsifiers used in the art like DATEM. New additives for food applications with a better dosis-concentration effect have been searched for since long.

The rhamnolipids can be added as an aqueous solution (in a liquid improver), as a dry powder (in a powder mix or in an oil type liquid improver) and/or as an emulsion.

In the method according to the invention, use of the rhamnolipid(s) can be combined with other additives such as synthetic emulsifiers (monoglycerides, diglycerides, diacetyl tartaric acid esters of monoglycerides (DATEM), stearoyllactylates, lecithine and the like), enzymes (α-amylase, xylanases, lipases, oxido reductases, proteases) and oxidantia (ascorbic acid, azodicarbonamide and bromate) who will improve dough stability, increase bread volume and/or improve crust and/or crumb texture. Different synergistic or cumulative effects are present depending on recipe and application.

Therefore, the method according to the invention will result in improved bakery products which are preferably selected from the group consisting of bread, hard rolls, soft rolls, hamburger buns, baguettes, flat bread, pizza, croissants, Chinese steam breads, Argentine breads, Schnittbrötchen, cake and sponge cake produced in a direct method as well as retarded proofing, overnight fermentation or frozen (unfermented, partially fermented and fully fermented) dough.

Rhamnolipids were also found to have a positive effect on the properties of for instance butter cream or decoration cream and on non-dairy cream filling for Danish pastries, croissants and other fresh or frozen fine confectionery products.

Another embodiment of the present invention relates to an improver composition, liquid, powder or emulsion, or a ready to use optimized mix, liquid, powder or emulsion comprising the rhamnolipid(s). An improver composition is a well-known concept amongst bakers. It is a mixture of at least two active ingredients such as enzymes, emulsifiers and oxido-reductantia, which are mixed with the usual ingredients for making bread, hard rolls, soft rolls, hamburger buns, baguettes, flat bread, pizza, cake or sponge cake and the like. The improver usually contains a carrier substance next to the active ingredients. These carrier substances can be wheat flour, soy flour, maize flour, starch or another food grade product as far as powder-form improvers are concerned. For liquid improvers the carrier can be oil, or water. It is also common in liquid improvers to add polysaccharides from microbial or vegetable origin to stabilize the liquid improver.

The rhamnolipids used can be produced (micro)biologically, e.g. by natural or genetically engineered (micro)organisms, or synthetically. They can for instance be harvested from Pseudomonas sp. culture broths such as broths from Pseudomonas sp. with accession numbers LMG P-22041 (DBT 302 T1), LMG P-22042 (DBT 303 T1), LMG P-22064 (DBT 302 T2), LMG P-22065 (DBT 303 T2) and LMG P-22040 (DBT 301) (see deposit receipts, incorporated by reference herein). These particular strains were not known before to produce rhamnolipids and rhamnolipid mixtures highly effective for one of the above-mentioned uses. An embodiment of the present invention concerns the use of these rhamnolipid producing Pseudomonas strains and the rhamnolipds produced by these strains. The rhamnolipids produced by these strains are not limited to those shown in FIGS. 2 and 3 and Table 17 (such as C₂₆H₄₈O₉ (RhC₁₀C₁₀), C₃₂H₅₈O₁₃ (RhRhC₁₀C₁₀) C₁₆H₂₆O₇ (RhC₁₀) or C₂₂H₃₆O₁₁ (RhRhC₁₀) rhamnolipids) but include also variants thereof. With variants is meant among others rhamnolipids with slightly different side chain such as for instance a somewhat longer or shorter side chain, like for instance Rh₂C₁₀C₁₂ and Rh₂C₁₀C₁₂—H₂, which can also be found within a rhamnolipid mixture (see Mata-Sandoval, cited above, for possible other rhamnolipids present in a Pseudomonas rhamnolipid mixture).

A further embodiment relates to an improver composition, liquid, powder or emulsion, or a ready to use optimized mix, liquid, powder or emulsion comprising the rhamnolipid(s) and at least one other improver component or compound that acts synergistically with said rhamnolipid in the increase of the stability of the dough or batter, the increase of the volume of the baked product (bread, cake or sponge cake), the improvement of the structure of the crust and/or the crumb during the baking process, the increase in the cut width and/or the decrease of microbiological deterioration of a baked product. Preferably, the rhamnolipids are added in a concentration of at least 0.01% (w/w) of rhamnolipids on flour in the final product.

Preferred improver compositions, liquids, powders or emulsions, or ready to use optimized mixes, liquids, powders or emulsions comprise at least one of RhC₁₀C₁₀ and RhRhC₁₀C₁₀. Even more preferred compositions, liquids, powders or emulsions, or ready to use optimized mixes, liquids, powders or emulsions comprise both of these. Preferably the amount of RhC₁₀C₁₀ and/or RhRhC₁₀C₁₀ on the total amount of rhamnolipids is higher than 70%, 80%, preferably higher than 90% or even higher than 95%. These compositions, preferably in the indicated concentrations, were surprisingly effective.

Particular synergistic compositions, liquid, powders, emulsion or ready to use mixes include synergistic mixtures comprising Lipase and rhamnolipids, ADA and rhamnolipids or gluten and rhamnolipids.

### BRIEF DESCRIPTION OF THE FIGURES

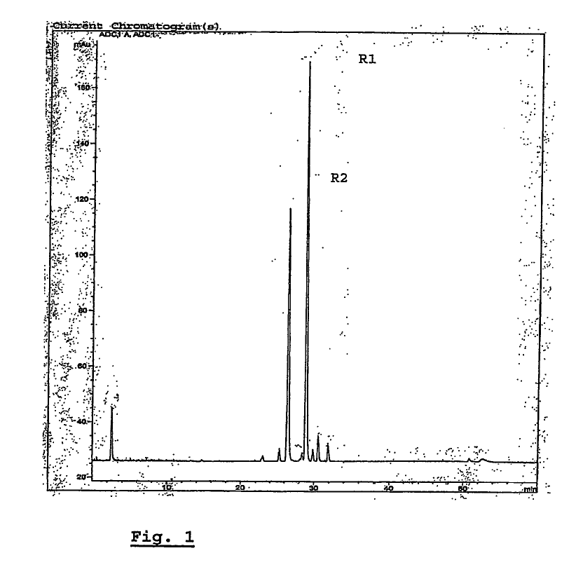

The FIG. 1 represents a HPLC analysis of rhamnolipids on a C18 column with a water/acetonitrile gradient.

The FIG. 2 represents a Maldi-TOF analysis of fraction R1 corresponding with RhC₁₀C₁₀.

The FIG. 3 represents a Maldi-TOF analysis of fraction R2 corresponding with RhRhC₁₀C₁₀.

### DETAILED DESCRIPTION OF THE INVENTION

The invention relates to the use of rhamnolipids in baked goods or products. This rhamnolipid bioemulsifier has a pronounced effect on for instance dough or batter stability, bread volume, bread shape, structure or texture, width of cut and/or microbiological or microbial conservation.

The rhamnolipids can be used in bread, hard rolls, soft rolls, hamburger buns, baguettes, flat bread, pizza, croissants, Chinese steam breads, Argentine breads, Schnittbrötchen, cake and sponge cake and other baked products where dough or batter stability, bread volume, bread shape, structure, width of the cut and/or microbiological conservation are quality issues.

The present invention will be described hereafter in detail in the following non-limiting examples and embodiments.

### EXAMPLES

### Example 1

Effect of rhamnolipid(s) on the specific loaf volume of bread.

The baking tests were performed in 100 g bread. The basic recipe was (in parts):

| | |
|---|---|
| Flour Surbi (Dossche Mills&bakery, Belgium): | 100 |
| Water: | 58 |
| Fresh Yeast (Bruggeman, Belgium): | 5 |
| Sodium Chloride: | 2 |
| Dextrose: | 2 |
| Ascorbic acid: | 0.004 |

The following breadmaking process was used: The ingredients were mixed for 4′4″ in a National 100 g pin-mixer. After bulk fermentation for 20′ at 25° C., 150 g dough pieces were made up using the Euro 200S (Bertrand-Electrolux Baking) set at R7/L9 and moulded. The dough pieces are proofed at 35° C. for 50′ at 95% relative humidity (RH). Then the breads are baked at 225° C. in a National Manufacturing (Lincoln, Nebr.) oven. It is obvious to one skilled in the art that same end results can be obtained by using equipment of other suppliers.

The volume of the bread was measured by rapeseed displacement.

The effect of addition of rhamnolipid(s) on loaf volume was compared to the effect of diacetyl tartaric acid esters of monoglycerides (DATEM). Addition of rhamnolipids did change the bread's specific loaf volume (Table 1).

TABLE 1

| Dosage in % | | |
|---|---|---|
| (w/w) on | | |
| flour | DATEM | Rhamnolipid |
| 0 | 100 | 100 |
| 0.025 | | 130 |
| 0.05 | | 134 |
| 0.075 | | 135 |
| 0.1 | 126 | 147 |
| 0.2 | 130 | 153 |
| 0.3 | 141 | |

The volume of a non-treated bread (no DATEM or rhamnolipid added) was set to 100.

The example shows that the use of rhamnolipid, at a dosage 8 times smaller than DATEM, increases bread volume significantly.

### Example 2

Effect of rhamnolipid(s) on the specific volume of hard rolls.

The basic recipe was (in parts):

| | |
|---|---|
| Flour Surbi (Dossche Mills&bakery, Belgium): | 100 |
| Water: | 62 |
| Fresh Yeast (Bruggeman, Belgium): | 6 |
| Sodium Chloride: | 2 |
| Standard improver: | 1 |

The standard improver contained (in w/w): Fungal alpha amylase (Bel´ase A75, Beldem, Belgium) 0.1%, xylanase (Bel´ase B210, Beldem, Belgium) 0.4%, vitamin C 1.5%, wheat flour 98%. This is an example of the standard improver. Absolute and relative amounts of additives can vary according to local adaptation to wheat flour and process.

The following breadmaking process was used: The ingredients were mixed in a spiral mixer (Diosna SP 24) for 2 minutes at low speed and for 8 minutes at high speed. After 25′ bulk fermentation, 2000 g dough is weighed and rounded manually. After an intermediate proofing of 10′ at 25° C., the dough is divided in pieces of 66.7 g and moulded (Rotamat). After 5′ fermentation, the dough pieces are pressed in the middle, closed and turned upside down (cut faced down) for 70 minutes proofing at 25° C. Proofed rolls are turned upside down again and baked in a deck oven (Miwe) for 20′ at 230° C. with appropriate steaming. It is obvious to one skilled in the art that some end results can be obtained by using equipment of other suppliers.

The volume of the rolls was measured by rapeseed displacement.

The effect of addition of rhamnolipid(s) on hard roll volume was compared to the effect of diacetyl tartaric acid esters of monoglycerides (DATEM). Addition of rhamnolipids did also change specific hard roll volume (Table 2).

TABLE 2

| Dosage in % (w/w) | | |
|---|---|---|
| on flour | DATEM | Rhamnolipid |
| 0 | 100 | |
| 0.025 | | 107 |
| 0.075 | | 111 |
| 0.1 | 110 | 121 |
| 0.2 | 113 | |
| 0.3 | 125 | |

The volume of a non-treated bread (no DATEM or rhamnolipid added) was set to 100.

Crispiness of the crust of hard rolls prepared with rhamnolipids or DATEM was comparable. Again, a much lower amount of rhamnolipids was needed to obtain the same effect as for DATEM.

### Example 3

Synergistic effect of lipase and rhamnolipid(s) on the volume of hard rolls.

The basic recipe was (in parts):

| | |
|---|---|
| Flour Surbi (Dossche Mills&bakery, Belgium): | 100 |
| Water: | 62 |
| Fresh Yeast (Bruggeman, Belgium): | 6 |
| Sodium Chloride: | 2 |
| Ascorbic acid: | 90 ppm |
| Fungal Alpha amylase: | 9 ppm |

Fungal alpha amylase was Bel´ase A75 (Beldem, Belgium). Lipase was Lipopan F™ (Trademark Novozymes, Denmark).

The following breadmaking process was used: The ingredients were mixed in a spiral mixer (Diosna SP 24) for 2 minutes at low speed and for 8 minutes at high speed. After 15′ bulk fermentation, 1500 g dough is divided and rounded and has an intermediate proofing of 10′. After this, dough is divided in dough pieces of 50 g and moulded (Rotamat). The dough pieces are placed on the baking trays and cut in the middle. After 70 minutes proofing the rolls are baked in a deck oven (Miwe) for 20′ at 230° C. with appropriate steaming.

It is obvious to one skilled in the art that some end results can be obtained by using equipment of other suppliers.

Hard roll volume was measured by rapeseed displacement.

The effect of the addition of rhamnolipid(s) on hard roll volume was compared to the effect of Lipopan F™ (Trademark of Novozymes, Denmark) and a synergistic effect between both additives was evaluated (Table 3).

TABLE 3

| Dosage % | | | |
|---|---|---|---|
| (w/w) | | | 0.002% (w/w) |
| on | | | Lipase on flour + |
| flour | Lipase | Rhamnolipid | Rhamnolipid |
| 0 | 100 | 100 | 100 |
| 0.002 | 111 | | |
| 0.006 | 119 | | |
| 0.05 | | 107 | 136 |
| 0.15 | | 127 | |

The volume of a non-treated bread (no lipase and/or rhamnolipid added) was set to 100.

A positive synergistic effect on hard roll volume is measured on addition of 0.002% lipase (w/w) on flour and 0.05% rhamnolipid (w/w) on flour.

### Example 4

Effect of rhamnolipid(s) on the shock resistance of a dough.

The basic recipe was (in parts):

| | |
|---|---|
| Flour Surbi (Dossche Mills&bakery, Belgium): | 100 |
| Water: | 58 |
| Fresh Yeast (Bruggeman, Belgium): | 5 |
| Sodium Cloride: | 2 |
| Ascorbic Acid: | 90 ppm |
| Fungal Alpha amylase: | 9 ppm |

Fungal Alpha amylase was Bel´ase A75 (Beldem, Belgium).

The following breadmaking process was used: The ingredients were mixed in a spiral mixer (Diosna SP 24) for 2 minutes at low speed and for 6 minutes at high speed. Dough is divided in pieces of 500 g, which are rounded manually. After 20′ intermediate proofing at 25° C., the dough pieces are moulded using the Euro 200S (Bertrand-Electrolux Baking) and put in the proofing box for 70′ at 35° C./95% RH. After proofing, one part of the loaves are placed immediately in the oven while the other part of the loaves are first shocked and subsequently baked for 35′ at 230° C. in a deck oven (Miwe) with appropriate steaming. During shock treatment, the baking trays containing the fermented dough pieces are lift at 15 cm above the table surface and then suddenly released. It is obvious to one skilled in the art that some end results can be obtained by using equipment of other suppliers.

The volume of the bread loaves was measured by rapeseed displacement.

The effect of addition of rhamnolipid(s) on shock resistance was compared to the effect of addition of diacetyl tartaric acid esters of monoglycerides (DATEM). Addition of rhamnolipids did change shock resistance of bread dough (Table 4).

TABLE 4

| Dosage % (w/w) on | DATEM | | Rhamnolipid | |
|---|---|---|---|---|
| flour | No shock | Shock | No shock | Shock |
| 0 | 100 | 74 | 100 | 74 |
| 0.1 | 108 | 86 | 114 | 112 |
| 0.15 | | | 119 | 118 |
| 0.2 | 111 | 109 | 126 | 123 |
| 0.3 | 120 | 119 | 122 | 118 |

The volume of a non-treated bread (no DATEM or rhamnolipid added and no shock treatment) was set to 100.

On addition of rhamnolipids, at only half of the DATEM dose, shock resistance of the dough is significantly increased.

### Example 5

Synergistic effect of rhamnolipid(s) and lipase on shock resistance of dough.

The basic recipe and the breadmaking process used are as described in example 4.

Lipase tested was Lipopan F™ (trademark of Novozymes, Denmark).

TABLE 5

| Dosage | | | | | | |
|---|---|---|---|---|---|---|
| % | | | | | 0.002% Lipase | |
| (w/w) | | | | | on flour + | |
| on | Lipase | | Rhamnolipid | | Rhamnolipid | |
| flour | No shock | Shock | No shock | Shock | No shock | Shock |
| 0 | 100 | 89 | 100 | 89 | 100 | 89 |
| 0.002 | 126 | 108 | | | | |
| 0.006 | 138 | 133 | | | | |
| 0.05 | | | 124 | 92 | 139 | 141 |
| 0.15 | | | 140 | 137 | | |

The volume of a non-treated bread (no lipase and/or rhamnolipid added and no shock treatment) was set to 100.

A synergistic effect on dough stability and bread volume is measured on addition of both lipase and rhamnolipids (Table 5).

### Example 6

Effect of rhamnolipid(s) on the volume of frozen hard rolls.

The basic recipe was (in parts):

| | |
|---|---|
| Flour Surbi (Dossche Mills&bakery, Belgium): | 100 |
| Water: | 56 |
| Fresh Yeast (Bruggeman, Belgium): | 6 |
| Sodium Chloride: | 2 |
| Standard improver: | 1 |

The composition of the standard improver is as described in Example 2.

The following breadmaking process was used: The ingredients were mixed in a spiral mixer (Diosna SP 24) for 2 minutes at low speed and for 8 minutes at high speed. After 5′ bulk fermentation at 25° C., dough pieces of 1500 g are rounded manually. After 10′ fermentation at 25° C., the dough pieces of 1500 g are divided in pieces of 50 g, moulded (Rotamat) and put (on baking trays) in the blast freezer (Koma) at −40° C. for 40′ and conserved in plastic bags at −-18 ° C. for 3 months. Frozen rolls are defrost at 25° C. for 60′ and proofed during 70′ at 35° C./95% RH before baking in a deck oven (Miwe) at 230° C. for 20′ with appropriate steaming. It is obvious to one skilled in the art that some end results can be obtained by using equipment of other suppliers.

The volume of the rolls was measured by rapeseed displacement.

The effect of addition of rhamnolipid(s) on loaf volume was compared to the effect of diacetyl tartaric acid esters of monoglycerides (DATEM) and gluten. Addition of rhamnolipids did change specific hard roll volume after freeze storage (Table 6).

TABLE 6

| Dosage in % | | | | Gluten |
|---|---|---|---|---|
| (w/w) on | | Gluten | | 2.5% + |
| flour | DATEM | 2.5% + DATEM | Rhamnolipid | rhamnolipid |
| 0 | 100 | 100 | 100 | 100 |
| 0.4 | 111 | 125 | | |
| 0.133 | | | 116 | |
| 0.2 | | | 127 | 134 |
| 0.267 | | | 131 | 134 |

The volume of a non-treated bread (no DATEM, gluten or rhamnolipids added) was set to 100.

After 3 months conservation at −18° C., a clear positive effect of rhamnolipids on hard roll volume and shape (more round) is measured. Rhamnolipid can replace both DATEM and gluten. A positive synergy on hard roll volume is measured on addition of gluten and rhamnolipid(s).

### Example 7

Activity of rhamnolipid(s) in a water based liquid improver.

Baking trials have been performed as described in example 3.

Respectively rhamnolipid and DATEM are added separately to a recipe containing a water based liquid improver. The activity of rhamnolipid added separately to and rhamnolipid incorporated into the water-based liquid improver and conserved for one month has been compared (Table 7).

The water based liquid improver contains: Fungal alpha amylase (Bel´ase A75, Beldem, Belgium) 1 g/100 kg flour, xylanase (Bel´ase B210, Beldem, Belgium) 4 g/100 kg flour, vitamin C 15 g.

TABLE 7

| | | | Rhamnolipid |
|---|---|---|---|
| | | | incorporated |
| | | | in liquid |
| | DATEM added | Rhamnolipid | improver |
| Dosage in % | separately | added | baked after 1 |
| (w/w) on | to liquid | separately to | month |
| flour | improver | liquid improver | conservation. |
| 0 | 100 | 100 | 100 |
| 0.285 | 109 | | |
| 0.142 | | 119 | 119 |

The volume of a non-treated bread (no DATEM or rhamnolipids added) was set to 100.

Addition of rhamnolipids at the same weight-dosage, has a higher positive effect on specific hard roll volume than DATEM. The results show a good stability of the activity of rhamnolipid during conservation into a water based liquid improver.

### Example 8

Effect of rhamnolipid(s) on the volume of overnight fermented (17 h, 20° C.) Argentine bread.

The basic recipe was (in parts):

| | |
|---|---|
| Flour Surbi (Dossche Mills&bakery, Belgium): | 100 |
| Water: | 54 |
| Fresh Yeast (Bruggeman, Belgium): | 0.35 |
| Sodium Chloride: | 2 |
| Standard improver: | 1 |

The composition of the standard improver is as described in Example 2.

The following breadmaking process was used: Dough was mixed in a (Diosna SP24) spiral mixer for 2 minutes at low speed and for 7 minutes at high speed. Dough pieces of 350 g are rounded and fermented at 25° C. for 20 minutes. After moulding (Bertrand, Electrolux Baking), dough pieces are fermented for 17 hours at 20° C., cut (lenghthwise incised with a sharp razor blade) and baked (210° C., 30 minutes, with appropriate steaming steaming). It is obvious to one skilled in the art that some end results can be obtained by using equipment of other suppliers.

The effect of addition of rhamnolipid(s) has been compared to the effect of DATEM.

Addition of rhamnolipids did change the specific loaf volume of the bread (Table 8).

TABLE 8

| Dosage in % (w/w) | DATEM | Rhamnolipid |
|---|---|---|
| on flour | Volume | Volume |
| 0 | 100 | 100 |
| 0.05 | | 114 |
| 0.075 | | 140 |
| 0.1 | | 150 |
| 0.2 | 135 | |

The volume of a non-treated bread (no DATEM or rhamnolipids added) was set to 100.

Rhamnolipids have a clear positive effect on bread volume of overnight fermented breads.

### Example 9

Effect of rhamnolipid(s) on the volume of overnight fermented (16 h, 26° C.) Argentine bread.

The basic recipe was (in parts):

| | |
|---|---|
| Flour Duo (Ceres, Belgium): | 100 |
| Water: | 54 |
| Fresh Yeast (Bruggeman, Belgium): | 0.075 |
| Salt: | 2 |
| Standard improver: | 1 |

The composition of standard improver is as described in example 2.

The following breadmaking process was used: Dough was mixed in a (Diosna SP24) spiral mixer for 2 minutes at low speed and for 7 minutes at high speed. Dough pieces of 350 g are rounded and fermented at 25° C. for 20 minutes. After moulding (Bertrand, Electrolux Baking), baguette shaped dough pieces are fermented for 16 hours at 26° C., cut lengthwise with 3 straight cuts of 2 mm depth and 10 cm length who overlap each other ⅓, per bread and baked in a deck oven (210° C., 30 minutes, with appropriate steaming). It is obvious to one skilled in the art that some end results can be obtained by using equipment of other suppliers.

Bread volume has been measured by rapeseed displacement.

TABLE 9

Dosage

| Rhamnolipid | | |
|---|---|---|
| % (w/w) on | ADA | |
| flour | ppm on flour | Volume |
| 0 | 0 | 100 |
| 0 | 40 | 114 |
| 0.075 | 0 | 110 |
| 0.1 | 0 | 112 |
| 0.15 | 0 | 116 |
| 0.1 | 40 | 133 |

The volume of a non-treated bread (no rhamnolipid or ADA=added) was set to 100. ADA=Azodicarbonamide

Rhamnolipid (0.1% w/w on flour) has the same effect on volume as 40 ppm ADA. A positive synergistic effect on volume of bread is measured on addition of both rhamnolipid 0.1% (w/w) on flour and ADA 40 ppm.

### Example 10

Effect of rhamnolipid(s) on the volume and shape of overnight fermented Schnittbrötchen.

The basic recipe was (in parts):

| | |
|---|---|
| Flour Surbi (Dossche Mills&bakery, Belgium): | 100 |
| Water: | 56 |
| Fresh Yeast (Bruggeman, Belgium): | 1 |
| Sodium Chloride: | 2 |
| Standard improver: | 1 |

The composition of the standard improver is as described in example 2.

The following breadmaking process was used: Dough was mixed with a spiral mixer (Diosna SP24) for 2 minutes at low speed and for 8 minutes at high speed. After 10 minutes bulk fermentation, dough pieces of 1600 g are rounded manually and intermediately proofed for 10′ at 25° C. Dough pieces of 53 g are formed, moulded (Rotamat) and rested for 1 minute at 25° C., moulded again using the Euro 200S (Bertrand-Electrolux Baking), rested for 8 minutes, cut, turned upside down and fermented for 17 hours at 15° C. Before baking, the dough pieces are turned upside down again and baked (16 minutes at 230° C., with appropriate steaming). It is obvious to one skilled in the art that some end results can be obtained by using equipment of other suppliers.

Bread volume is measured by rapeseed displacement. The width of cut of the resulting breads is measured as the largest distance between the two upstanding edges of the cut after baking.

The effect of addition of rhamnolipid on loaf volume was compared to the effect of diacetyl tartaric acid esters of monoglycerides (DATEM). Addition of rhamnolipids did change the specific loaf volume and width of cut (Table 10).

TABLE 10

| | DATEM | | Rhamnolipid | |
|---|---|---|---|---|
| Dosage in % (w/w) | | Width of | | Width of |
| on flour | volume | cut (mm) | volume | cut (mm) |
| 0 | 100 | 0 | 100 | 0 |
| 0.405 | 111 | 19 | | |
| 0.15 | | | 130 | 32 |
| 0.20 | | | 132 | 36 |

Volume and width of cut are significantly improved on addition of rhamnolipids at one third of the dose of DATEM.

### Example 11

Influence of rhamnolipid(s) on the volume and shape of partially fermented frozen hard rolls.

The basic recipe was (in parts):

| | |
|---|---|
| Flour Paniflower Exclusiv | 100 |
| (Ganda Molens/Brabo Mills, Belgium): | |
| Water: | 57 |
| Fresh Yeast (Bruggeman, Belgium): | 3 |
| Sodium Chloride: | 2 |
| Dextrose: | 0.4 |
| Standard improver: | 1 |

The composition of the standard improver is as described in Example 2.

The following breadmaking process was used: The ingredients were mixed in a spiral mixer (Diosna SP 24) for 2 minutes at low speed and for 7 minutes at high speed. After 10′ bulk fermentation at 25° C. dough pieces of 90 g are formed. After 90′ proofing dough pieces are cut once lengthwise and frozen at −18° C. for 120′ (Koma stockfreezer) packed in plastic bags and conserved at −18° C. for one week. Frozen rolls are defrost at 25° C. for 30′ and baked in a rotating oven (Miwe Aeromat) at 230° C. for 27′ with appropriate steaming. It is obvious to one skilled in the art that some end results can be obtained by using equipment of other suppliers.

The volume of the rolls was measured by rapeseed displacement.

TABLE 11

| Dosage in % (w/w) | | |
|---|---|---|
| on flour | DATEM | Rhamnolipid |
| 0 | 100 | 100 |
| 0.250 | 102 | 110 |
| 0.500 | 108 | 117 |

The volume of a non-treated bread (no DATEM or rhamnolipids added) was set to 100.

Rhamnolipids, added at the same weight dosage as DATEM, have a higher positive effect on volume of partially fermented frozen hard rolls (Table 11).

### Example 12

Effect of rhamnolipid (s) on the volume and shape of croissants.

The basic recipe was (in parts):

| | |
|---|---|
| Flour Duo (Ceres, Belgium): | 100 |
| Water: | 51 |
| Fresh Yeast (Bruggeman, Belgium): | 7.5 |
| Sodium Chloride: | 1.7 |
| Sugar: | 8 |
| Aristo Croissant (Puratos, Belgium): | 42 |

The following breadmaking process was used:

The ingredients were mixed in a spiral mixer (Diosna SP 24) for 2 minutes at low speed and for 2 minutes at high speed. After 5′ bulk fermentation at 25° C., the fat is spread on the dough surface and the dough piece is laminated: sheeted fold up, turned at 90° and sheeted again. Dough pieces of 55 g are weighed; sheeted and the croissants are formed. After 55′ proofing (30° C., 90% relative humidity), the croissants are baked in a deck oven (Ooms) for 19′ at 195° C. with appropriate steaming.

It is obvious to one skilled in the art that some end results can be obtained by using equipment of other suppliers. The volume of the croissants was measured by rapeseed displacement.

TABLE 12

| Dosage | | | | | | |
|---|---|---|---|---|---|---|
| in % | DATEM | | | Rhamnolipid | | |
| (w/w) | | | Crumb | | | Crumb |
| on | | | struc- | | | struc- |
| flour | Volume | Shape | ture | Volume | Shape | ture |
| 0 | 100 | OK | OK | 100 | OK | OK |
| 0.150 | 107 | OK | OK | 125 | OK | OK |
| 0.300 | 113 | OK | OK | 122 | OK | OK |

The volume of a non-treated bread (no DATEM or rhamnolipids added) was set to 100.

On addition of rhamnolipids, the volume of the croissants is higher while the aspect of the crust, lamination, colour of crumb and shape of the product are comparable as on addition of DATEM (Table 12).

### Example 13

Effect of rhamnolipid(s) on the volume and the shape of Chinese steam bread.

The effect of rhamnolipids on the volume and the shape of Chinese steam bread was compared to the effect of Sodium Stearoyl Lactylate (SSL).

The basic recipe was (in parts):

| | |
|---|---|
| Flour Surbi (Dossche Mills&bakery, Belgium): | 100 |
| Water: | 50 |
| Dry Instant Yeast Blue (Bruggeman, Belgium): | 1 |
| Vitamin C: | 3 |

The following breadmaking process was used: The ingredients were mixed in a spiral mixer (Diosna SP 24) for 8 minutes at low speed. The dough piece (1500 g) is sheeted until a final thickness of 2.5 mm, after each sheeting dough is fold up. The final dough sheet is rolled and dough pieces of 100 g are cut. After proofing, 35′ at 90% Relative Humidity, the dough pieces are steamed for 18 minutes. It is obvious to one skilled in the art that some end results can be obtained by using equipment of other suppliers.

Bread volume is measured by rapeseed displacement.

Rhamnolipids influence shape and volume of Chinese steam buns significantly (Table 13).

TABLE 13

| Dosage | | | | | | |
|---|---|---|---|---|---|---|
| in % | | | | | | |
| (w/w) | | | | | SSL 0.10% + | |
| on | SSL | | Rhamnolipid | | Rhamnolipid | |
| flour | Volume | Height | Volume | Height | Volume | Height |
| 0 | 100 | 44 | 100 | 44 | | |
| 0.05 | | | 102 | 46 | 118 | 52 |
| 0.1 | 119 | 49 | | | | |
| 0.15 | | | 121 | 52 | | |
| 0.3 | 96 | 43 | | | | |

The volume of a non-treated bread (no DATEM or rhamnolipids added) was set to 100.

By replacement of 0.1% SSl (w/w) on flour with 0.15% rhamnolipid (w/w) on flour, the same bun volume is obtained while the shape of the bun, the height, is improved.

### Example 14

Effect of rhamnolipid(s) on the volume of sponge cake.

The basic recipe was (in parts):

| | |
|---|---|
| Mix for sponge cake: | 100 |
| Water: | 11 |
| Egg: | 80 |
| Emulsifier*: | 4 |

*= lactic acid esters of mono-and diglycerides

The mix for sponge cake contains: flour (38% w/w), sugar (42% w/w), maize starch (16% w/w), chemical leavening powder (4% w/w).

The following preparation process was used: All ingredients are mixed with a Hobart N50 planet mixer for 30 seconds at speed 1 and for 5 minutes at speed 3. Batter, 200 g, is baked in rectangular pans for 30 minutes at 180° C. in a deck oven (Miwe).

Volume was measured by rapeseed displacement (Table 14).

TABLE 14

| Dosage | | | Crumb | Crumb |
|---|---|---|---|---|
| % (w/w) on | Volume | | structure | color |
| dry mix | Emulsifier | Rhamnolipid | Rhamnolipid | |
| 0 | 100 | 100 | | |
| 2 | 110 | | | |
| 0.075 | | 113 | More fine | More white |
| 0.15 | | 110 | More fine | More white |
| | | | More soft, | |
| | | | less loss of | |
| | | | softness | |
| | | | during | |
| | | | conservation | |
| | | | (5 days) | |

The volume of a non-treated bread (no emulsifier or rhamnolipid added) was set to 100.

In the recipe of sponge cake, Lactic acid esters of monoglycerides can partially be replaced by rhamnolipids without losing volume and with improving crumb structure, more absolute softness and less loss of softness during conservation, and whiter crumb colour (Table 14).

### Example 15

Effect of rhamnolipid(s) on properties of butter cream.

Lactic acid esters of mono-and diglycerides of fatty acids have been replaced by rhamnolipids in the formula of a liquid preparation for butter cream and decoration cream.

The liquid preparation for butter cream and decoration cream contains (w/w): glucose syrup 45%, sugar 30%, water 20%, skimmed milk powder 3%, eggs in powder 1%, emulsifiers: lecithin (E322) 0.3%; (lactic acid esters of mono-and diglycerides of fatty acids (E 472)) 0.1%, alginate <1%.

The basic recipe used was (w/w):

| | |
|---|---|
| Butter: | 50% |
| Water: | 10% |
| Liquid preparation for butter cream: | 40% |

The following preparation process was used: All ingredients are mixed in a Hobart N50 planet mixer for 5 minutes at speed 1 and for 30 seconds at speed 3.

Color, texture and ease of application have been evaluated by an experienced technician (Table 15).

TABLE 15

| | Lactic acid esters | |
|---|---|---|
| | of mono-and | |
| Dosage % (w/w) in | diglycerides of | |
| liquid preparation | fatty acids | Rhamnolipids |
| 0.05 | | Light pale yellow |
| | | Smooth and soft |
| | | Smooth surface |
| | | after application |
| 0.1 | Pale yellow | Light pale yellow |
| | Not homogenous | Smooth and soft |
| | Not completely | Smooth surface |
| | smooth surface | after application |
| | after application | |

### Example 16

effect of rhamnolipid(s) on non-dairy cream filling for Danish pastries, croissants and other fresh or frozen fine confectionery products.

Polysorbate 60 has been replaced by rhamnolipids in non-dairy cream filling for pastries.

The basic recipe was (w/w): glucose syrup 45%, water 30%, sugar 15%, modified starch 5%, vegetable fats 3%, salt <1%, coloring agent: titanium dioxide (E171)<1%, flavor <1%, (polysorbate 60 (E 435)<0.5%, tartrazine (E 102)<1%, Yellow FCF (E110)<1%.

The following preparation process was used: The starch is mixed with the water, sugar and glucose syrup are added together with the emulsifier and titanium dioxide. After mixing until homogenous all the other ingredients are added and mixed again. The total mixture is heated until jellification of the starch.

Bake stability (180° C., 30 minutes), color, taste, speed of incorporation of fat into the mixture and possible separation of fat during conservation are evaluated (Table 16).

TABLE 16

| Dosage % (w/w) in | | |
|---|---|---|
| liquid preparation | Polysorbate 60 | Rhamnolipids |
| 0.005 | | Somewhat less |
| | | gelled and less |
| | | viscous but still |
| | | acceptable |
| 0.01 | Processing OK | No significant |
| | Bake stability OK | differences with |
| | Colour, taste OK | reference |
| | Stable during | |
| | conservation | |

### Example 17

Production of rhamnolipids by Pseudomonas species:

The Pseudomonas strains were selected based on their emulsification activity during the fermentation in Erlenmeyer flasks on a medium suitable for the growth of the strains. Five selected Pseudomonas strains producing rhamnolipids have been deposited under de Budapest Treaty. They have the following collection numbers: LMG P-22041 (strain DBT 302 T1), LMG P-22042 (strain DBT 303 T1), LMG P-22064 (strain DBT 302 T2), LMG P-22065 (strain DBT 303 T2) and LMG P-22040 (strain DBT 301). They were all deposited at the BCCM/LMG bacterial collection, Laboratorium voor Microbiologie, Universiteit Gent (RUG), K. L. Ledegankcstraat 35 , B-900 Gent, BELGIUM on 3 Oct. 2003 (see deposits receipts).

a) Selection Medium

The strains were incubated at 30° C. for 7 days on a shaker in a 500 ml Erlenmeyer flask containing 100 ml of mineral salt medium (see below).

Mineral Salt Medium:

A buffer of 0.05 M K₂HPO₄/KH₂PO₄ (pH 6.8) was used supplemented with glucose (10 g/l), NH₄Cl (1 g/l), MgSO₄.7H₂O (0.2 g/l)and trace elements: CaCl₂ (15 mg/l), FeSO₄.7H₂O (10 mg/l), CuSO₄.5H₂O (2 mg/l), ZnSO₄.7H₂O (2 mg/l), MnSO₄.H₂O (1.5 mg/l), CoCl₂.6H₂O (0.2 mg/l) and Na₂MoO₄ (0.2 mg/l). For conservation, strains were inoculated on Gika medium composed of glucose (5 g/l), yeast extract (5 g/l), CaCO₃ (40 g/l) and agar (15 g/l).

b) Production of Rhamnolipids

Lyophilized strains were dissolved in a buffer composed of glucose (5 g/l), K₂HPO₄ (0.8 g/l) and KH₂PO₄ (0.2 g/l) and were inoculated on plates with King B medium composed of peptone (20 g/l), glycerol (10 g/l), K₂HPO₄ (1.5 g/l), MgSO₄.7H₂O (1.5 g/l), yeast extract (0.5 g/l) and agar (15 g/l). The pH of the medium was adjusted at pH 7.2. After 48 hours, the strains were inoculated on slants with King B medium to obtain a fresh culture. From these slants, a preculture was made so that the microorganism can adapt at the new culture medium. Therefore, 4 ml of sterilised water was added to the slant to obtain a suspension of the culture. 1 ml was added to 100 ml of production medium (see below) and after 48 hours 1 ml of this preculture was added to 100 ml of production medium (see below).

Production Medium:

The production medium is composed of K₂HPO₄ (1 g/l), KH₂PO₄ (0.5 g/l), NaNO₃ (4 g/l), MgSO₄.7H₂O (0.5 g/l), KCl (0.1 g/l), CaCl₂(0.01 g/l), FeSO₄.7H₂O (0.01 g/l), yeast extract (0.01 g/l) and a solution of trace elements (0.05 ml/l). Olive oil was used as carbon source (25 g/l). The solution of trace elements was composed of B (0.26 g/l), Cu (0.5 g/l), Mn (0.5 g/l), Mb (0.06 g/l) and Zn (0.7 g/l).

The medium was adjusted at pH 6.8 and sterilized for 30 minutes at 121° C.

Cultures of Pseudomonas species are performed at 150 rpm, 30° C. and pH 6.8 in 500 ml Erlenmeyer flasks with baffles, each containing 100 ml production medium. Production of rhamnolipids was detected after 72 hours in the culture supernatant after centrifugation.

c) Detection of Rhamnolipids

The rhamnolipids were extracted by acid precipitation or by lyophilisation and dissolved in chloroform or water. TLC analysis was performed with chloroform/methanol/water (65/25/4). Fluorescein was used for detection of lipids and diphenylamine was used for distinction between rhamnolipids and lipopeptides.

Rhamnolipids were isolated using an HPLC instrument and an ELSD detector. A Vydac C₁₈ column (250×4.6 mm) and a gradient method using solvent A (H₂O) and solvent B (acetonitrile): (75/25 for 5 min; from 75/25 to 5/95 for 30 min; 5/95 for 5 min; from 5/95 to 75/25 for 10 min; 75/25 for 15 min at a flow-rate of 0.4 ml/min were used for the purification of the rhamnolipids.

The different fractions corresponding with the different peaks of the chromatogram (R1 and R2: see FIG. 1) were collected and analysed using Maldi-TOF.

Table 17 shows the different masses of the rhamnolipids without and with added salts. Fraction R1 corresponds with rhamnolipid RhC₁₀C₁₀ (see FIG. 2) and fraction R2 corresponds with rhamnolipid RhRhC₁₀C₁₀ (see FIG. 3). Other rhamnolipids like RhRhC₁₀ and RhC₁₀ could also be presented but in quantities to low to be detected by HPLC.

TABLE 17

| | Mass | Mass + Na | Mass + K |
|---|---|---|---|
| RhC₁₀C₁₀:C₂₆H₄₈O₉ | 504 | 527 | 543 |
| RhRhC₁₀C₁₀:C₃₂H₅₈O₁₃ | 650 | 673 | 689 |
| RhC₁₀:C₁₆H₂₆O₇ | 330 | 353 | 369 |
| RhRhC₁₀:C₂₂H₃₆O₁₁ | 476 | 499 | 515 |

1. A method for increasing or improving of at least one of the following properties of a bakery product or dough: microbial conservation, volume, dough stability, batter stability, shape, width of cut, crumb texture, crust texture, properties of butter cream, decoration cream and/or non-dairy cream filling for Danish pastries, croissants and other fresh or frozen fine confectionary products, the method comprising the step of adding a sufficiently effective amount of a rhamnolipid in said bakery product or dough.

2.-7. (canceled)

8. The method claim 1, wherein the rhamnolipid is added as a dry powder.

9. The method of claim 1, wherein the rhamnolipid is added as an aqueous solution or emulsion.

10. The method of claim 1, further comprising the step of adding at least one other additive selected from the group consisting of α-amylase, xylanase, lipase, oxido-reductase, ascorbic acid, azodicarbonamide, monoglycerides, diacetyl tartaric acid of monoglycerides, stearoyllactylates and propionates.

11. The method of claim 1, wherein the bakery product is selected from the group consisting of bread, hard rolls, soft rolls, hamburger buns, baguettes, flat bread, pizza, croissants, Chinese steam breads, Argentine breads, Schnittbrötchen, sponge cakes and cakes.

12. A bread improver composition comprising at least 0.01% (w/w) of a rhamnolipid on flour in a final product, and other usual active ingredients selected from the group consisting of enzyme emulsifiers and oxido reductantia, wherein the rhamnolipid increases or improves at least one of the following qualities of a bakery product or dough: volume, cut width, dough stability, batter stability crumb texture, crust texture, and/or microbial conservation.

13. The bread improver composition of claim 12, which is a liquid, powder, or emulsion.

14. The bread improver composition of claim 12, further comprising at least one other improver component that acts synergistically with the rhamnolipids(s).

15. The bread improver composition of claim 14, wherein said other improver component is Lipase.

16. The bread improver composition of claim 14, wherein said other improver component is Lipopan F and wherein the synergistic mixture increases the volume of baked products.

17. The bread improver composition of claim 14, wherein said other improver component is Lipopan F and wherein the synergistic mixture increases dough stability of bakery products.

18. The bread improver composition of claim 14, wherein said other improver component is gluten and wherein the synergistic mixture increases the volume of bakery products when added to a dough that is later frozen in between mixing and baking.

19. The bread improver composition of claim 14, wherein said other improver component is ADA and wherein the synergistic mixture increases the volume of bakery products when added to an overnight fermented dough.

20. The bread improver composition of claim 12, wherein the rhamnolipids are obtained from a culture broth of Pseudomonas sp. fermentation.

21. The bread improver composition of claim 20, wherein said Pseudomonas sp. is selected from the group consisting of LMG P-22041, LMG P-22042, LMG P-22064, LMG P-22065 and LMG P-22040.

22. The bread improver composition of claim 20, wherein the culture broth comprises at least one of the following: a RhC₁₀C₁₀, RhRhC₁₀C₁₀, RhC₁₀ or a RhRhC₁₀ rhamnolipid or a variant thereof with a shorter or longer side chain.

23. (canceled)

24. (canceled)

25. The method of claim 1, wherein at least one rhamnolipid is selected from the group consisting of RhC₁₀C₁₀ and RhRhC₁₀C₁₀ is added to the bakery product or the dough.

26. The bread improver composition of claim 12, comprising at least one rhamnolipid selected from the group consisting of RhC₁₀C₁₀ and RhRhC₁₀C₁₀.
